(19) United States
(12) Patent Application Publication
(10) Pub. No.: US 2006/0208607 A1
(43) Pub. Date: Sep. 21, 2006

(54) Actuator with double plate structure

(75) Inventors: Yong-seop Yoon, Seoul (KR); Hyung Choi, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/369,727

(22) Filed: Mar. 8, 2006

(30) Foreign Application Priority Data
Mar. 16, 2005 (KR) 10-2005-0021846

(51) Int. Cl. G02B 26/08; H02N 1/00

(52) U.S. Cl. 310/309; 359/223; 359/225; 239/290

(57) ABSTRACT

An actuator, including: a substrate; a middle plate supported above the substrate to be rotatable, about a rotation axis, with respect to the substrate; a stage connected to and spaced above the middle plate; a pair of first driving electrodes located on the substrate around the rotation axis; and a pair of second driving electrodes located on the substrate surrounding the first driving electrodes. Torsion springs connect opposite sides of the middle plate to support the middle plate above the substrate. A connecting member connects the stage and middle plate.

### CROSS-REFERENCE TO RELATED PATENT APPLICATION

This application is based upon and claims the benefit of priority from Korean Patent Application No. 10-2005-0021846, filed on Mar. 16, 2005, in the Korean Intellectual Property Office, the disclosure of which is incorporated herein in its entirety by reference.

### BACKGROUND OF THE INVENTION

1. Field of the Invention

Devices, systems, and methods consistent with the invention relate to an actuator with a double plate structure.

2. Description of the Related Art

An actuator is used as an optical scanner for reflecting a laser beam, in a display appliance such as a projection television. The optical scanner can be driven by electrostatic force and is manufactured from a micro-electromechanical system (MEMS). FIG. 1 is a perspective view illustrating an example of the structure of a flat type electrostatically driven optical scanner according to the related-art. As shown in FIG. 1, the optical scanner of the related-art includes a stage 20 supported above a substrate 10, a mirror 22 on the stage 20, torsion springs 30 extending from both sides of the stage 20, anchors 40 holding the ends of the torsion springs 30 to the substrate 10, and a pair of driving electrodes 51 and 52 on the substrate 10. The driving electrodes 51 and 52 are spaced on either side of the torsion spring 30, which is the rotation axis of the mirror 22.

FIG. 2 is a cross-sectional view for explaining the operation of the related-art optical scanner with the above construction. When a voltage is applied to the driving electrode 51, the stage 20 is rotated to one side by the electrostatic force between the driving electrode 51 and the stage 20. That is, the stage rotates by a driving angle θ. The restoring force of the torsion spring 30 returns the stage 20 to its original position. Thus, the voltage applied to the driving electrodes 51 and 52 can be controlled to give the stage 20 a periodic motion with a certain driving angle and velocity (i.e., driving frequency).

The driving angle varies with the driving voltage. The electrostatic force is expressed by the following equation 1.
F=(εAV²)/D² (Equation 1)

where ε is the dielectric constant, A is the area of the stage, and D is the distance between the stage and the electrode.

Accordingly, the driving force on the stage 20 increases in proportion to the square of the distance D as the stage 20 moves closer to the driving electrodes 51 and 52. However, since the restoring force of the torsion spring 30 is proportional to the angle of rotation, if the stage is rotated too far, the restoring force becomes smaller than the driving force, and the stage 20 can contact the driving electrode 51 or 52, thereby making it difficult to adjust the driving angle.

Therefore, there are limits to how much the driving angle of the optical scanner can be increased. Also, in order to increase the restoring force of the torsion spring and the driving angle, the higher driving voltage must be applied.

### SUMMARY OF THE INVENTION

According to an aspect of the invention, an actuator is provided with a double plate structure by which a driving angle is increased with a low driving voltage.

According to another aspect of the invention, there is provided an actuator with a double plate structure, including a substrate; a middle plate supported above the substrate by torsion springs extending from its opposite sides, and which is rotatable about a rotation axis linking the torsion springs; a stage connected to and spaced above the middle plate by a connecting member; a pair of first driving electrodes located on the substrate around the rotation axis; and a pair of second driving electrodes located on the substrate surrounding the first driving electrodes.

According to another aspect of the invention, the area of the middle plate is smaller than that of the stage.

According to another aspect of the invention, the area of the first driving electrode is smaller than that of the second driving electrode.

According to another aspect of the invention, the actuator may further include an electrical conductor connecting the first and second driving electrodes.

According to another aspect of the invention, the stage may be parallel to the middle plate.

According to another aspect of the invention, there is provided an actuator with a double plate structure, including a substrate; a stage supported above the substrate by torsion springs extending from its opposite sides, and which is rotatable about a rotation axis linking the torsion springs; a middle plate connected to and spaced below the stage by a connecting member; a pair of first driving electrodes located on the substrate around the rotation axis; and a pair of second driving electrodes located on the substrate surrounding the first driving electrodes.

### BRIEF DESCRIPTION OF THE DRAWINGS

The above and/or other aspects of the invention will become more apparent by describing in detail exemplary embodiments of the invention with reference to the attached drawings in which:

FIG. 1 is a perspective view illustrating an example of the structure of a related-art optical scanner;

FIG. 2 is a cross-sectional view explaining the operation of the related-art optical scanner;

FIG. 3 is a perspective view illustrating an actuator with a double plate structure according to a first exemplary embodiment of the invention;

FIG. 4 is a cross-sectional view taken along a line IV-IV of FIG. 3;

FIG. 5 is a view explaining the operation of the invention;

FIG. 6 is a view explaining the horizontal movement of the center point of a stage and the vertical movement of a reflecting surface according to a double plate structure of the invention;

FIG. 7 is a cross-sectional view illustrating an actuator according to a second exemplary embodiment of the invention;

FIG. 8 is a plan view showing electrodes on a substrate;

FIG. 9 is a view explaining the operation of an actuator according to the second exemplary embodiment of the invention; and

FIG. 10 is a cross-sectional view illustrating an actuator with a double plate structure according to a third exemplary embodiment of the invention.

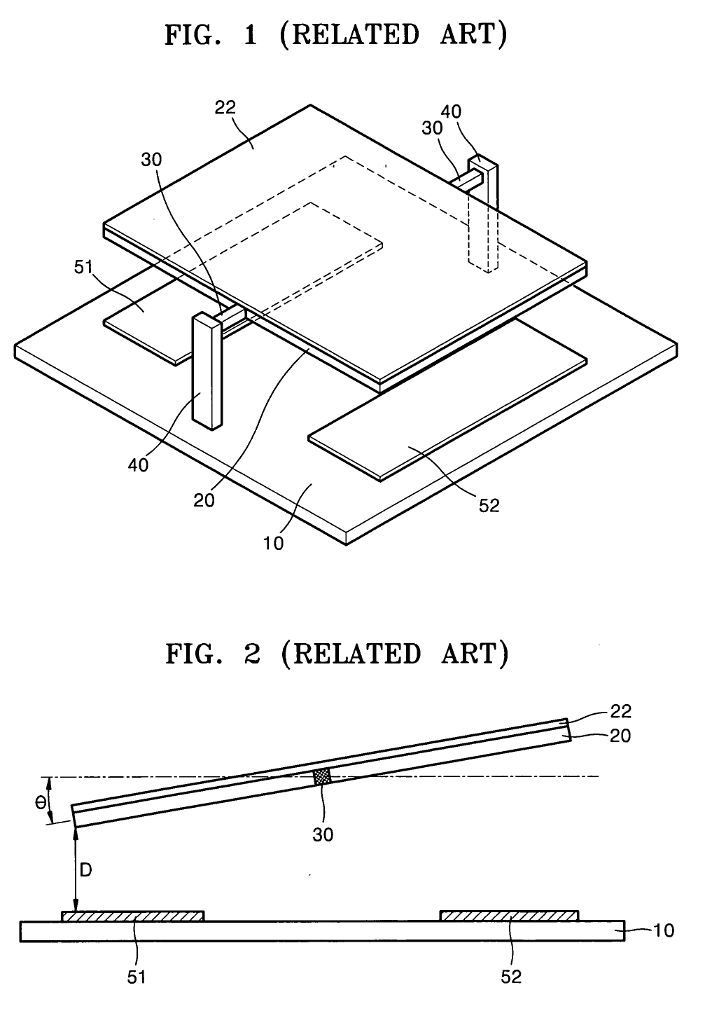

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like numbers refer to like elements throughout the specification.

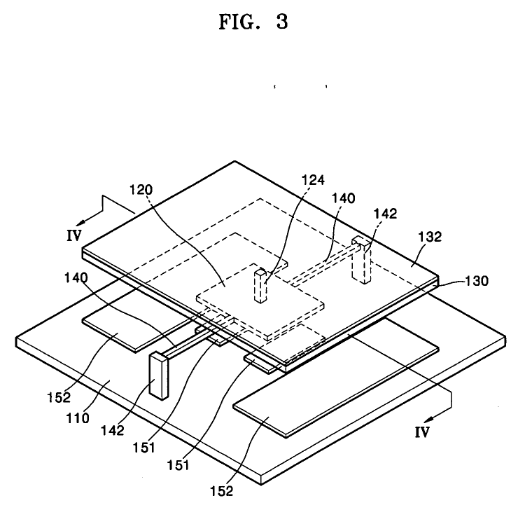

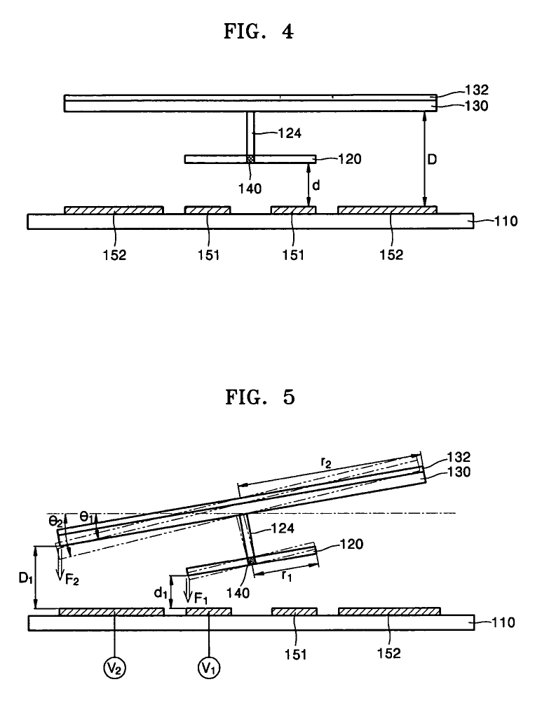

FIG. 3 is a perspective view illustrating an actuator with a double plate structure according to a first exemplary embodiment of the invention, and FIG. 4 is a cross-sectional view taken along a line IV-IV of FIG. 3.

Referring to FIGS. 3 and 4, the actuator includes a middle plate 120 supported above a substrate 110, a stage 130 fixed above the middle plate 120, torsion springs 140 extending from opposite sides of the middle plate 120, anchors 142 holding the ends of the torsion springs 140 above the substrate 110, and driving electrodes 151 and 152 formed on the substrate 110. A mirror 132 with a light-reflecting surface may be further formed on the stage 130.

The driving electrodes 151 and 152 consist of a pair of first driving electrodes 151 spaced around the rotation axis of the torsion springs 140, and a pair of second driving electrodes 152 surrounding the first driving electrodes 151. A circuit is constructed such that different voltages may be applied to the first and second driving electrodes 151 and 152. The substrate 110 may be made from pyrex glass or silicon (or similar material), and the driving electrodes 151 and 152 may be made from conductive metal such as chromium, Indium-Tin Oxide (ITO) (or similar material).

The stage 130 is connected to and spaced apart from the middle plate 120 by a connecting member 124. The stage 130, the connecting member 124, the middle plate 120, the torsion springs 140, and the anchors 142 may be made from a conductive material (e.g., polysilicon). The stage 130 is parallel to the middle plate 120. The area of the stage 130 is larger than that of the middle plate 120.

The distance d between the first driving electrode 151 and the middle plate 120 is less than the distance D between the second driving electrode 152 and the stage 130.

When a first voltage V₁ is applied to one of the first driving electrodes 151, the stage 130 is rotated to one side by an electrostatic force F₁ between the first driving electrode 151 and the middle plate 120. The electrostatic force can be expressed by the following equation 2.
F₁=(ε×A₁×V₁²)/d² (Equation 2)

where ε is the dielectric constant, A₁ is the area of the middle plate 120, and d is the distance between the middle plate 120 and the first driving electrode 151.

Compared with the electrostatic force (F of Equation 1) of the related-art actuator without the middle plate 120, if F₁=F to exert the same driving angle, and A=2×A₁ and D=2×d, then V₁ is equal to V/\sqrt{2}. Accordingly, the driving voltage of the actuator with the middle plate 120 of the invention is lower than that of the related-art actuator. The driving voltage V₁ may vary with the area and position of the middle plate 120. That is, as the distance d between the substrate 110 and the middle plate 120 is less, the driving voltage is lower.

FIG. 5 is a view for explaining the operation of the invention. Referring to FIG. 5, when the first driving voltage V₁ is applied to the middle plate 120, a torque T₁(T₁=F₁×r₁) is generated, depending upon the electrostatic force F₁ between the first driving electrode 151 and the middle plate 120, thereby rotating the stage 130 by an angle θ₁. Then, when a second voltage V₂ is applied to the second driving electrode 152, an electrostatic force F₂ is generated. The electrostatic force F₂ can be expressed by the following Equation 3.
F₂=(ε×A₂×V₂²)/D₁² (Equation 3)

where ε is the dielectric constant, A₂ is the area of the stage 130, and D₁ is the distance between the stage 130 and the second driving electrode 152.

A torque T₂ (T₂=F₂×r₂) is exerted, depending upon the electrostatic force F₂ between the second driving electrode 152 and the stage 130. At an initial state, the electrostatic force F₁ is larger than F₂, but as the driving angle increases, F₂ also increases. Since r₂ is much larger than r₁, T₂ becomes larger than T₁. Here, r₁ and r₂ are the respective lengths of the pivot arms of the middle plate 120 and the stage 130. Accordingly, with an increase of the driving force and torque, the stage 130 and the middle plate 120 rotate further up to an angle θ₂.

Therefore, by controlling the voltage applied to the first and second driving electrodes 151 and 152, it is possible to increase the driving angle of the stage 130. Also, by applying the first voltage to initially rotate the stage 130, and then applying a low voltage to the second driving electrode 152, the torque exerted on the stage 130 is increased, so that the driving angle can be increased even with a low voltage.

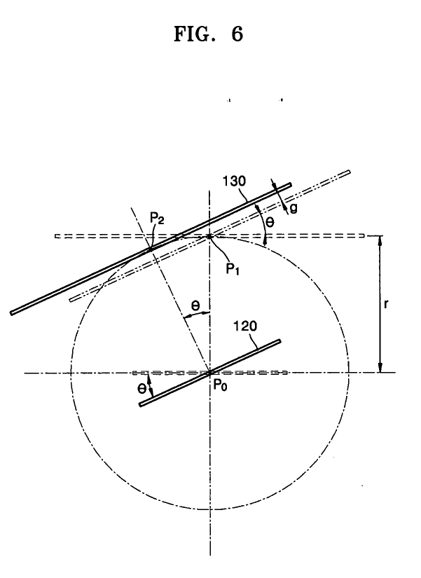

FIG. 6 is a view for explaining the horizontal movement of the center point of the stage 130 and the vertical movement of a reflecting surface, according to a double plate structure of the invention.

Referring to FIG. 6, when the stage 130 rotates by an angle θ, the rotation axis of the middle plate 120 remains at the center point P₀, which is fixed. However, the center point P₁ of the stage 130 rotates to a position P₂ along the circumference of a circle as the middle plate 120 rotates. If the distance between the middle plate 120 and the stage 130 is r, the moving distance of the center point of the stage 130 can be expressed by the following Equation 4.
Dm=2πr×θ/360 (Equation 4)

where Dm is the moving distance (the length of an arc) of the center point between P₁ and P₂, r is the distance between the stage 130 and the middle plate 120, and θ is the driving angle.

When r is 50 μm and θ is 10 degrees, Dm is 8.7 μm. Meanwhile, the mirror 132 of the stage 130 may have a length of 1 to 1.5 mm, so that the movement of the center point of the mirror 132 does not cause a problem.

Meanwhile, when rotated by the angle shown in FIG. 6, the solid line indicates the top of the stage 130 rotated about the rotation axis of the middle plate 120, and the dotted line indicates the position of the stage 130 rotated about the center point P₁ of the stage 130. A vertical length-g between the positions of the stage 130 indicated by the dotted line and the solid line can be expressed by the following Equation 5.
g=r−r cos θ (Equation 5)

In Equation 5, if r is 50 μm and θ is 10 degrees, g is 0.76 μm. This value is a negligible value in the optical scanner.

It can be therefore known that even when the center point of the reflecting surface is rotated, the actuator with the double plate structure of the invention can be used as an optical scanner.

The operation of the actuator according to a first exemplary embodiment of the invention will now be explained with reference to the drawings.

First, when the first voltage V₁ is applied to the first driving electrode 151, the stage 130 rotates by a first angle θ₁ about the rotation axis of the torsion spring 140. Then, when the second voltage V₂ is applied to the second driving electrode 152, the stage 130 rotates further, from the first angle θ₁ to a second angle θ₂. After that, the first voltage V₁ can be turned off.

Then, if the second voltage V₂ is turned off, the stage 130 returns to its rest state.

Next, if voltages are applied in sequence to the first and second driving electrodes 151 and 152 on the other side, the stage 130 rotates in the opposite direction, and then when those voltages are turned off, the stage 130 returns again to its rest state. Accordingly, by adjusting the voltage applied to the driving electrodes, it is possible to rotate the mirror 132 periodically with a certain driving angle and driving velocity (driving frequency).

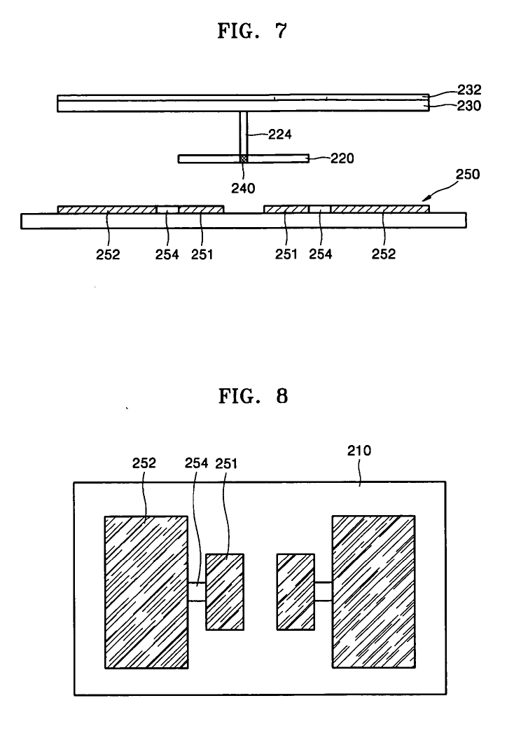

FIG. 7 is a cross-sectional view illustrating an actuator according to a second exemplary embodiment of the invention, and FIG. 8 is a plan view showing electrodes on the substrate. In FIGS. 7 and 8, elements which are substantially the same as those of the first exemplary embodiment are identified with similar terms, and a detailed explanation thereof will be omitted.

Referring to FIGS. 7 and 8, the actuator includes a middle plate 220 supported above a substrate 210, a stage 230 fixed above the middle plate 220, a mirror 232 on the stage 230, torsion springs 240 extending from opposite sides of the middle plate 220, anchors 242 supporting the ends of the torsion spring 240 above the substrate 210, and driving electrodes 250.

The driving electrodes 250 consist of a pair of first driving electrodes 251 spaced around the rotation axis of the torsion springs 240, and a pair of second driving electrodes 252 surrounding the first driving electrodes 251. The first and second driving electrodes are electrically connected together by an electric conductor 254.

The stage 230 is connected to and spaced apart from the middle plate 220 by a connecting member 224. The stage 230, the connecting member 224, the middle plate 220, the torsion springs 240 and the anchors 242 may be made from a conductive material (e.g., polysilicon). The stage 230 is parallel to the middle plate 220. The area of the stage 230 is larger than that of the middle plate 220.

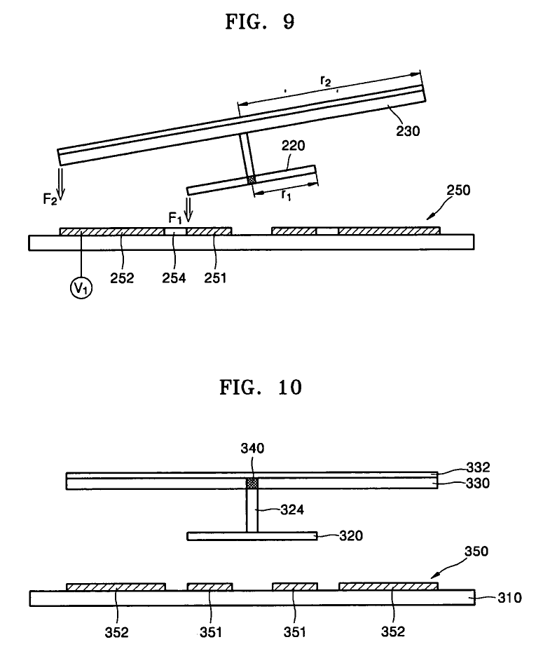

FIG. 9 is a view for explaining the operation of an actuator according to the second exemplary embodiment of the invention.

Referring to FIGS. 7 to 9, when a voltage is applied to one of the driving electrodes 250, a torque T₁ (T₁=F₁×r₁) is exerted according to the electrostatic force F₁ between the particular driving electrode 250 and the middle plate 220, and a torque T₂ (T₂=F₂×r₂) is exerted according to the electrostatic force F₂ between the particular driving electrode 250 and the stage 230. At the rest position, the electrostatic force F₁ is larger than F₂, but as the driving angle increases, F₂ increases. Since r₂ is much larger than r₁, T₂ becomes larger than T₁. Here, r₁ and r₂ are the respective lengths of the pivot arm of the middle plate 220 and the stage 230.

Meanwhile, the driving electrodes 250 consist of the first driving electrode 151 and the second driving electrode 252, and the area of the first driving electrode 251 is smaller than that of the second driving electrode 252. The electrostatic force between the middle plate 220 and the first driving electrode 251 begins to rotate the stage 230, and the electrostatic force between the stage 230 and the second driving electrode 252 rotates the stage further. Accordingly, although the driving voltage V₁ is lower than the threshold voltage for the maximum driving angle of the middle plate 220, the driving angle is increased by driving the stage 230, thereby controlling and increasing the driving angle of the stage 230 within the threshold voltage.

The operation of the second exemplary embodiment of the actuator will now be explained with reference to the drawings.

First, when the first voltage V₁ is applied to the driving electrodes 250, the stage 230 is driven mainly by the force F₁ on the middle plate 220, which is larger than the force F₂ on the stage 230. Then, after a point, the force F₂ becomes larger than the force F₁ and the distance r2 to the center of rotation is larger, so that the torque increases. Thus, if the driving angle exceeds a certain angle, the torque is increased mainly by the force F₂, allowing a larger driving angle. Therefore, the driving angle may be increased even using a low driving voltage.

Then, if the first voltage is turned off, the stage 230 returns to its rest position.

Next, if a voltage is applied to the other side driving electrodes, the stage 230 rotates in the opposite direction, and then if the voltage to those electrodes is turned off, the stage 230 returns to its rest position. Accordingly, by controlling the voltage applied to the driving electrodes 250, it is possible to rotate the mirror 232 periodically with a certain driving angle and driving velocity (driving frequency).

FIG. 10 is a cross sectional view illustrating an actuator with a double plate structure according to a third exemplary embodiment of the invention. In FIG. 10, elements which are substantially the same as those of the first exemplary embodiment are identified with similar terms, and a detailed explanation thereof will be omitted.

Referring to FIG. 10, the actuator includes a middle plate 320 supported above a substrate 310, a stage 330 fixed above the middle plate 320, a mirror 332 on the stage 330, torsion springs 340 extending from opposite sides of the stage 330, an anchor 342 holding the ends of the torsion springs 340 above the substrate 310, and driving electrodes 350 formed on the substrate 310.

The driving electrodes 350 consist of a pair of first driving electrodes 351 spaced around the rotation axis of the torsion springs 340, and a pair of second driving electrodes 352 surrounding the first driving electrodes 151. A circuit is constructed such that separate voltages may be applied to the first and second driving electrodes.

The stage 330 is connected to and spaced apart from the middle plate 320 by a connecting member 324. The stage 330, the connecting member 324, the middle plate 320, the torsion springs 340 and the anchors 342 may be made from a conductive material (e.g., polysilicon).

The actuator according to the third exemplary embodiment of the invention differs from that of the first exemplary embodiment in that the rotation axis is at the stage 330, but the operation thereof is substantially identical to that of the first exemplary embodiment, and a detailed explanation thereof will be omitted.

As described before, according to the actuator of the invention, the middle plate is installed between the stage and the substrate, and can be driven with low driving voltage. In addition, if one side of the stage approaches the substrate, the driving angle can be increased by the electrostatic force between the stage and the driving electrode. Accordingly, the actuator of the invention can be used as an optical scanner in display devices.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. An actuator, comprising:
a substrate;
a middle plate supported above the substrate to be rotatable, about a rotation axis, with respect to the substrate;
a stage connected to and spaced above the middle plate;
a pair of first driving electrodes located on the substrate around the rotation axis; and
a pair of second driving electrodes located on the substrate surrounding the first driving electrodes.

2. The actuator according to claim 1, further comprising torsion springs connected to opposite sides of the middle plate to support the middle plate above the substrate.

3. The actuator according to claim 1, further comprising a connecting member connecting the stage and the middle plate.

4. The actuator according to claim 1, wherein an area of the middle plate is smaller than an area of the stage.

5. The actuator according to claim 1, wherein an area of the first driving electrode is smaller than an area of the second driving electrode.

6. The actuator according to claim 1, further comprising an electrical conductor connecting the first and second driving electrodes.

7. The actuator according to claim 6, wherein an area of the first driving electrode is smaller than an area of the second driving electrode.

8. The actuator according to claim 1, wherein the stage is parallel to the middle plate.

9. The actuator according to claim 1, further comprising a mirror on an upper surface of the stage.

10. The actuator according to claim 1, wherein: the middle plate is spaced apart from the first driving electrode by a first distance; the stage is spaced apart from the second driving electrode by a second distance; and the second distance is greater than the first distance.

11. An actuator, comprising:
a substrate;
a stage supported above the substrate to be rotatable, about a rotation axis, with respect to the substrate;
a middle plate connected to and spaced below the stage;
a pair of first driving electrodes located on the substrate around the rotation axis; and
a pair of second driving electrodes located on the substrate surrounding the first driving electrodes.

12. The actuator according to claim 11, further comprising torsion springs connected to opposite sides of the stage to support the stage above the substrate.

13. The actuator according to claim 11, further comprising a connecting member connecting the stage and the middle plate.

14. The actuator according to claim 11, wherein an area of the middle plate is smaller than an area of the stage.

15. The actuator according to claim 11, wherein an area of the first driving electrode is smaller than an area of the second driving electrode.

16. The actuator according to claim 11, further comprising an electrical conductor connecting the first and second driving electrodes.

17. The actuator according to claim 16, wherein an area of the first driving electrode is smaller than an area of the second driving electrode.

18. The actuator according to claim 11, wherein the stage is parallel to the middle plate.

19. The actuator according to claim 11, further comprising a mirror on an upper surface of the stage.

20. The actuator according to claim 11, wherein: the middle plate is spaced apart from the first driving electrode by a first distance; the stage is spaced apart from the second driving electrode by a second distance; and the second distance is greater than the first distance.
